(19) United States
(12) Patent Application Publication
(10) Pub. No.: US 2006/0171755 A1
(43) Pub. Date: Aug. 3, 2006

(54) Dual-head dye-sub thermal transfer printer system and method

(76) Inventor: Bryan Clarke, Aurora, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/047,221

(22) Filed: Jan. 31, 2005

(51) Int. Cl. B41J 2/315

(52) U.S. Cl. 400/120.02

(57) ABSTRACT

The method and system for multi-color printing on a sheet of media includes the steps of and mechanisms for moving a sheet of media and a first segment of a first dye ribbon beneath a first printing head in a first direction while printing parallel to the direction of movement of the media; and moving the sheet of media and a first segment of a second dye ribbon beneath a second printing head in a reverse direction while printing parallel to the direction of movement of the media in the reverse direction. When four colors are desired the method and system further include the steps of and mechanisms for moving the sheet of media and a second segment of the first dye ribbon beneath the first printing head in the first direction while printing parallel to the direction of movement of the media; and, moving the sheet of media and a second segment of the second dye ribbon beneath the second printing head in the reverse opposite direction while printing parallel to the direction of movement of the media.

### BACKGROUND OF THE INVENTION

1. Field of the Invention

The present invention relates to a dual-head dye-sub thermal transfer color printer system and method where the media to be printed is reciprocated beneath two printing heads each having a multi-color dye transfer ribbon which moves with the media to improve printing speeds by eliminating the wasted time in backing up the media to print the next color.

2. Description of the Related Art

In thermal transfer dye-sub color printing there are primarily two basic designs for ribbon panels, four panel single ribbon and continuous four single color ribbons. In both designs, ribbon is wound to a core or spindle and limited to a predetermined volume of prints as the ribbon is expired after one use. In the four panel single ribbon design, the ribbon contains a single panel for each of the four colors (yellow, magenta, cyan and overcoat). The size of each panel is the same as the maximum print size of a finish photo plus the tolerance required by the printer horizontal alignment and panel sensing. Panels may be oriented vertically or horizontal. For example, panels for a 4″×6″ photo may be 4.2″×6.2″; the total linear length of the ribbon to print one photo would be 24.8″ for horizontal panels or 16.8″ for vertical panels.

To ensure that colors do not bleed from subsequent color passes, the printer must determine panel locations on the ribbon. Panels are identified for registration with several different methods including black marks, transitions sensing, and “ink” voids.

Black marks are identified with a transmissive sensor which senses the high contrast of the black mark by blocking infrared light. Voids are sensed similarly to black marks with the exception of passing more infrared light. New sensors can now sense the color transitions themselves and require no identifying marks.

In the continuous four ribbon design, there are no panels or sensing marks. Each ribbon roll contains just one color.

Although, these are the most common printing systems, additional variations of these configurations are exercised. The protective overcoat layer may be eliminated leaving just three panels in a single ribbon design or just three continuous ribbons. Additional colors may be added, particularly black to provide additional richness of dark areas.

Heretofore, many printing systems have been proposed.

In one prior art printing system, wire impact dot matrix printing with three printheads was used as opposed to the use of two thermal printheads in the apparatus of the present invention. This system used a multicolored ribbon, striped longitudinally as opposed to the use of two ribbons having alternating transversely extending colored ribbon panels in the apparatus of the present invention and the alternate colors are printed through a pass while the apparatus of the present invention prints one colored panel at a time and prints parallel to the direction of movement of the media with alternating colored panels on at least two ribbons. This system and other prior art systems print perpendicular to the movement of the media.

In another prior art printing system, printing is carried out in only one direction with multiple printheads and single color ribbons as opposed to bi directional printing with two multi-colored ribbons carried out with the apparatus of the present invention.

Bi-directional printing systems for printing with a black ribbon and a multi-colored longitudinally striped ribbon where the printing direction is perpendicular to the direction of travel of the media and alternate colors are printed through one pass have been proposed. Such systems do not use at least two ribbons which have having alternating transversely extending colored ribbon panels for printing in a direction parallel to the direction of movement of the media and which print only one color in a direction parallel to the direction of movement of the media in one pass.

Finally, it has also been proposed to use a two-ribbon set with color combinations. In this prior art system only one printhead is used and the two sets of ribbons are interlaced one on top of the other. Between color panel sets there is a cutout section of no ribbon in each ribbon. When it is time for the other ribbon color to be applied, the first ribbon positions the void area over a platen to apply just one ribbon color from the other ribbon.

### BRIEF SUMMARY OF THE INVENTION

According to one of the teachings of the present invention there is provided a method and system for multi-color printing on a sheet of media including the steps of and mechanisms for:

moving a sheet of media and a first segment of a first dye ribbon beneath a first printing head in a first direction while printing parallel to the direction of movement of the media; and

moving the sheet of media and a first segment of a second dye ribbon beneath a second printing head in a reverse while printing parallel to the direction of movement of the media in the reverse direction.

Often it is desirable to print more colors such as three or four colors, four being more common. When four colors are desired the method and system further include the steps of and mechanisms for

moving the sheet of media and a second segment of the first dye ribbon beneath the first printing head in the first direction while printing parallel to the direction of movement of the media; and,

moving the sheet of media and a second segment of the second dye ribbon beneath the second printing head in the reverse direction while printing parallel to the direction of movement of the media.

The method and system of the present invention provide a mechanical improvement in the handling of the media to be printed.

### BRIEF DESCRIPTION OF THE SEVERAL VIEWS OF THE DRAWINGS

FIG. 1 is a diagram of the dual head dye-sub color printer system of the present invention and shows a sheet of media loaded for printing.

FIG. 2 is a diagram of the dual head dye-sub color printer system of the present invention as shown in FIG. 1 after the media has been moved with a first ribbon to effect cyan printing.

FIG. 3 is a diagram of the dual head dye-sub color printer system of the present invention as shown in FIG. 2 after the media has been moved in the reverse with the second ribbon to effect magenta printing.

FIG. 4 is a diagram of the dual head dye-sub color printer system of the present invention as shown in FIG. 3 after the media has been moved with the first ribbon to effect yellow printing.

FIG. 5 is a diagram of the dual head dye-sub color printer system of the present invention as shown in FIG. 4 after the media has been moved in the reverse with the second ribbon to effect overcoat printing.

FIG. 6 is a diagram of the dual head dye-sub color printer system of the present invention as shown in FIG. 5 after the media has been moved with the first ribbon to effect release of the printed media.

### DETAILED DESCRIPTION OF THE INVENTION

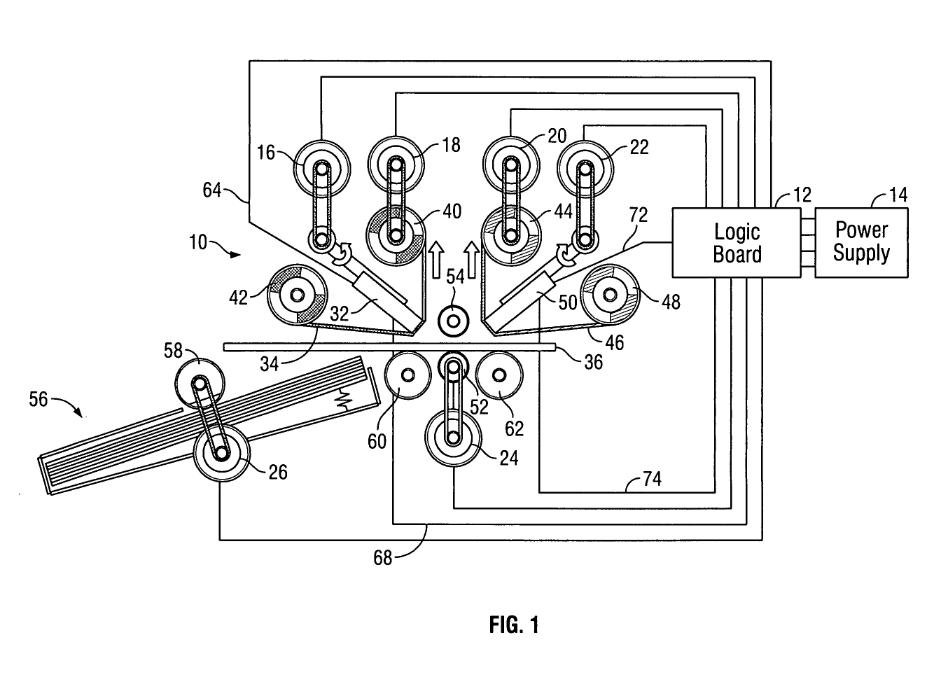

Referring now to FIG. 1 there is illustrated therein a vertical diagram of the dual-head dye-sub thermal transfer color printer system of the present invention generally identified by the reference numeral 10. The printer system 10 includes a logic board 12, connected to a power supply 14. The logic board 12 controls drive motors graphically shown in FIG. 1 at 16, 18, 20, 22, 24 and 26. The first motor 16 controls swivel movement of a first printer head 32, for moving a first ribbon 34 toward a sheet 36 of media to be printed referred hereinafter as simply media 36. The second motor 18, controls take up movement of a take up roller 40, for the first ribbon 34 from a supply roller 42. The motor 20, controls movement of a second take up roller 44 for a second ribbon 46 from a second supply roller 48.

The motor 22 controls the swinging movement of a second printer head 50. The motor 24 controls movement of a drive a nip roller 52 of a pair of nip rollers 52 and 54 for moving the media 36 first to the right, then to the left, next to the right and finally to the left for ejection of the printed media 36 from the printer system 10.

The motor 26 is associated with a magazine 56 and drives a feed roller 58, for feeding the uppermost sheet 36, of a stack of media 36 into the printer system 10, where the media 36 is supported by a pair of spaced apart rollers 60 and 62 located on either side of the drive nip roller 52.

Control lines 64 and 68 control operation of the first printer head 32 and control lines 70 and 74 control the second printer head 50, e.g. heating of the printer head.

The first ribbon 34 has alternate segments of cyan and yellow and the first printer head 32 is referred to as the “CY” (cyan-yellow) head 32. The alternating ribbon color segments are typically four by six inches (4″×6″) or six by four inches (6″×4″.) The second ribbon 46 has alternating segments of magenta and overcoat material. The second printer head 50 is referred to as the “MO” (magenta-overcoat) head.

In FIG. 1 the CY head 32 is up and the MO head 50 is up. Then the feed roller 58 is operated to move the top sheet of media 36 into position on the spaced apart support rollers 60 and 62.

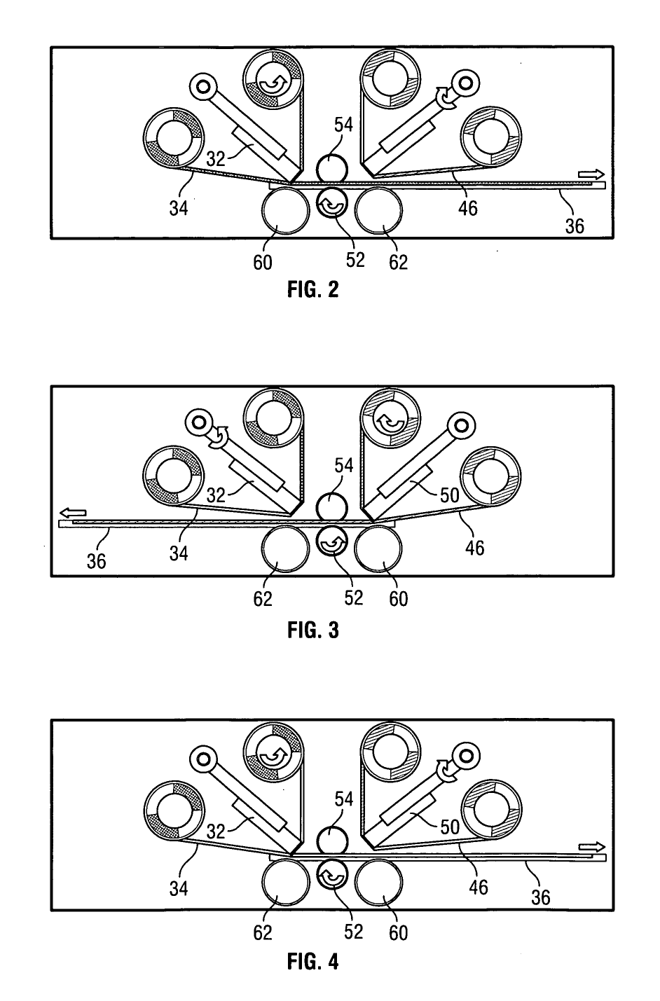

Then as shown in FIG. 2 the CY head 32 is moved down and the nip rollers 52 and 54 engage the media 36 and the drive nip roller 52 moves the media 36 to the right while the cyan is printed on the media 36 from the first ribbon 34.

Then as shown in FIG. 3 the CY head 32 is moved up and the MO head 50 is moved down to apply magenta from a segment of the second ribbon 46 to the media 36 as the nip rollers 52 and 54 move the media 36 to the left.

Next as shown in FIG. 4 the CY head 32 is moved down and the MO head 50 is up and the nip rollers 52 and 54 drive the media 36 to the right as the CY head 32 applies yellow from a segment of the first ribbon 34 to the media 36.

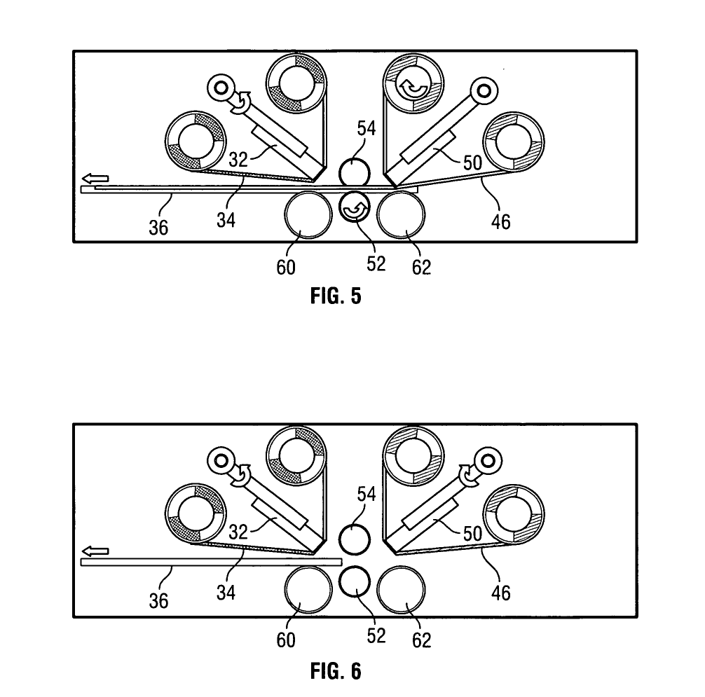

As shown in FIG. 5 the CY head 32 is moved up the MO head 50 is moved down and the nip rollers 52 and 54 move the media 36 to the left as an overcoat layer from a segment of the second ribbon 46 is placed on the media 36 by the MO head 50.

Finally, as shown in FIG. 6 the CY head 32 is moved up, the MO head 50 is moved up and the nip rollers 52 and 54 are released from the media 36 to enable the printed media 36 to be released from the printer system 10.

By using a dual head printer and reciprocating the media back and forth e.g., left and right, the printing time for a sheet of media 36 can be reduced about 25-30%.

It will be understood that the overcoat is a clear material that stabilizes the chemistry in the dye-sub ribbon layers applied to the media 36. The clear overcoat also provides a UV protective layer to prevent bleed-out from the media 36 which would cause the image to fade.

From the foregoing description it will be apparent that the printer system and method of printing have a number of advantages some of which have been described above and others of which are inherent in the system and method.

In particular, a primary benefit of the method and system of the present invention is the increase in printing speeds obtained by bi-directional printing.

Printing can be performed in two printing passes instead of four. For example, while printing a 4″×6″ vertical photo using the method and system of the present invention only 16.8 feet of linear travel of the media is required while a prior art single ribbon printer requires 33.6 feet of linear travel.

Further, while four single color ribbon printing in only one pass enables multiple photos to be processed at one time, the four ribbons and four printhreads in this type of printer are much more expensive than the printing system and method of the present invention.

Also modifications can be made to the printer system and method of the present invention without departing from the teachings of the invention.

For example, various numbers of colors can be printed with the method and system of the present invention, typically from 2 to 6 colors with four being the most common number of colors. In this context the overcoat is considered a “color”.

Two, three, four, five six, etc. colors may be employed. Current dye-sub printers use three colors and an overcoat. Development of new dye technology may eliminate the need for an overcoat for stabilization.

Also one may desire to add black to the colors resulting in five colors, e.g. four colors and the overcoat. Still further, in the future, one may desire to add a specific ribbon color for better printing of that color rather than the CMY processed color.

Further, while sheet feeding of the media has been disclosed herein, the system and method works equally as well with a continuous fed media and a cutter.

Accordingly, the scope of the invention is only to be limited as necessitated by the accompanying claims.

I claim:

1. A method for multi-color printing on a sheet of media including the steps of:
moving a sheet of media and a first segment of a first dye ribbon beneath a first printing head in a first direction while printing parallel to the direction of movement of the media; and,
moving the sheet of media and a first segment of a second dye ribbon beneath a second printing head in an opposite direction while printing parallel to the direction of movement of the media.

2. The method of claim 1 wherein the first dye segment of the first dye ribbon is cyan.

3. The method of claim 1 wherein the first dye segment of the second dye ribbon is magenta.

4. The method of claim 1 further including the steps of:
moving the sheet of media and a second segment of the first dye ribbon beneath the first printing head in the first direction while printing parallel to the direction of movement of the media; and,
moving the sheet of media and a second segment of the second dye ribbon beneath the second printing head in the opposite direction while printing parallel to the direction of movement of the media.

5. The method of claim 4 wherein the second dye segment of the first dye ribbon is yellow.

6. The method of claim 4 wherein the second dye segment of the second dye ribbon is overcoat material.

7. The method of claim 6 wherein said overcoat material includes a clear stabilizing material that stabilizes the chemistry in the dye-layers applied to the media.

8. The method of claim 6 wherein said overcoat material is a clear material that provides a UV protective layer to prevent bleed-out of the dye from the media.

9. The method of claim 1 wherein the first dye ribbon has alternating color or coating segments.

10. The method of claim 1 wherein the second dye ribbon has alternating color or coating segments.

11. A system for multi-color printing on a sheet of media comprising:
a first moving mechanism for moving a sheet of media in a first direction;
a second moving mechanism for moving a first segment of a first dye ribbon beneath a first printing head in the first direction in conjunction with movement of the sheet of media in the first direction;
control circuitry for causing said movements of said first and second moving mechanisms;
a third moving mechanism; and,
said control circuitry being constructed and arranged to cause reverse movement of said first moving mechanism for moving the sheet of media with a first segment of a second dye ribbon beneath a second printing head in a reverse direction; and,
to cause movement of said third moving mechanism for moving the first segment of the second dye ribbon beneath a second printing head in the reverse direction in conjunction with said movement of the sheet of media in the reverse direction.

12. The system of claim 11 wherein said first moving mechanism comprises a pair of nip rollers.

13. The system of claim 11 wherein said second moving mechanism comprises a take up roller.

14. The system of claim 11 wherein said third moving mechanism comprises a take up roller.

15. The system of claim 11 wherein said first dye segment of said first dye ribbon is cyan.

16. The system of claim 11 wherein said first dye segment of said second dye ribbon is magenta.

17. The system of claim 11 wherein said control mechanism is further constructed and arranged to:
cause said first moving mechanism to move in said first direction for moving the sheet of media with a second segment of said first dye ribbon beneath said first printing head in said first direction;
cause said second moving mechanism to move said second segment of said first dye ribbon beneath said first printing head in the first direction in conjunction with movement of the sheet of media in the first direction;
cause said first moving mechanism to move in said reverse direction for moving the sheet of media with a second segment of said second dye ribbon beneath said second printing head in said reverse direction; and,
cause said third moving mechanism to move the second segment of the second dye ribbon beneath said second printing head in the reverse direction in conjunction with said movement of the sheet of media in the reverse direction.

18. The system of claim 17 wherein said second dye segment of said first dye ribbon is yellow.

19. The system of claim 17 wherein said second dye segment of said second dye ribbon is an overcoat material.

20. The system of claim 19 wherein said overcoat material includes a clear stabilizing material that stabilizes the chemistry in said dye-layers applied to the media.

21. The system of claim 19 wherein said overcoat material is a clear material that provides a UV protective layer to prevent bleed-out of said dye from the media.

22. The system of claim 11 wherein the first dye ribbon has alternating color or coating segments.

23. The system of claim 11 wherein the second dye ribbon has alternating color or coating segments.
